(19) United States
(12) Patent Application Publication
(10) Pub. No.: US 2016/0145895 A1
(43) Pub. Date: May 26, 2016

(54) ARRANGEMENT FOR INDICATING THE STATE OF THE LOCK OF A DOOR WITH INDICATION LIGHTS, AND A FACE PLATE

(71) Applicant: ROLLOCK OY, Espoo (FI)

(72) Inventor: Hannu KANKKUNEN, ESPOO (FI)

(73) Assignee: ROLLOCK OY, ESPOO (FI)

(21) Appl. No.: 14/785,242

(22) PCT Filed: Apr. 15, 2014
(86) PCT No.: PCT/FI2014/050271

§ 371 Date: Oct. 16, 2015

(30) Foreign Application Priority Data
Apr. 17, 2013 (FI) 20135381

(51) Int. Cl. E05B 17/10; E05B 1/00; E05B 9/02; E05B 41/00

(52) U.S. Cl. CPC E05B 17/10; E05B 41/00; E05B 1/0053; E05B 1/0061; E05B 9/02

(57) ABSTRACT

Arrangement for indicating the state of the lock of a door with indication lights, which lock includes a lock case installed in a lock housing inside the door, a handle for opening the door, and a face plate installed onto the surface of the door. The face plate covers the lock housing and through which the handle is installed. Indication lights are installed in the lock case behind the face plate, and at least one aperture is made in the face plate, through which the light is visible from the front of the door.

### FIELD OF TECHNOLOGY

The object of the present invention is an arrangement for indicating the state of the lock of a door with indication lights, which lock comprises a lock case installed in a lock housing inside the door, a handle, by means of which the door is opened, and a face plate installed onto the surface of the door, which face plate covers the lock housing and through which the handle is installed.

### PRIOR ART

The invention thus relates to the locks of doors, said locks comprising at least a lock case, a face plate on the surface of the door, and a handle (doorhandle) installed in the normal way through the face plate, by means of which door handle the door is finally opened:

The invention further relates to those types of door locks in. which indication lights are used to indicate the state of the lock. The lights can be many different colors. For example, green can mean that the lock can be opened by pressing the handle, red can indicate that the lock cannot be opened, et cetera.

Conventionally, lights indicating the state of a lock are implemented with lights that are installed in the door or in the door frame by drilling a hole/holes at certain points and by installing the lights plus their wiring into the holes. This causes extra work and costs. These types of installations might also detract from the elegance/appearance of the door.

### SUMMARY OF THE INVENTION

The purpose of the present invention is to achieve a new type of arrangement for indicating the state of a lock with indication lights, to which arrangement the drawbacks occurring in prior art are not attached. The arrangement according to the invention is characterized in that the indication lights are installed in the lock case behind the face plate, and in that at least one aperture is made in the face plate, through which aperture the light is visible from the front of the door.

The arrangement according to one preferred embodiment of the invention is characterized in that the aperture is essentially ring-shaped apart from the fixing bridge between the rest of the face plate and the center part of the face plate, and in that the ring-shaped aperture surrounds the stem part of the handle.

The arrangement according to a second preferred embodiment of the invention is characterized in that an inside piece that is of light-diffusing material is fixed behind the face plate in the lock case, in the bottom side of which inside piece recesses are made for one or more LED lights.

Yet another preferred embodiment of the arrangement according to the invention is characterized in that there are two LED lights and two different colors are selectable in each of them.

Another aim of the invention is also to achieve a new type of face plate. The face plate according to the invention is characterized in that a groove is made in the face plate, via which groove the light coming from under the face plate is visible.

One preferred embodiment of the faceplate according to the invention is characterized in that the groove is essentially circular in shape apart from the fixing bridge between the rest of the face plate and the center part of the face plate, and in that the circular groove surrounds the stem part of the handle.

One of the advantages of the invention that can be mentioned is that the light indication is arranged in the lock case, in which case extra holes or other machining procedures in the door are not needed. This saves, inter alia, costs. Since the indication lights are compactly installed in the lock case, the outward appearance of the door remains advantageous and the light indication is stylishly implemented. Installation of the lock according to the invention does not require any work phases other than normal. Any handle whatsoever on the market can be used in the invention.

### SHORT DESCRIPTION OF THE DRAWINGS

In the following, the invention will be described in more detail by the aid some embodiments with reference to the attached drawings, wherein

FIG. 1 presents a handle and a face plate according to the invention.

FIG. 2 presents a top view of the face plate.

FIG. 3 presents a bottom view of the inside piece.

FIG. 4 presents the nested placement of the inside piece and the face plate.

### DETAILED DESCRIPTION OF THE INVENTION

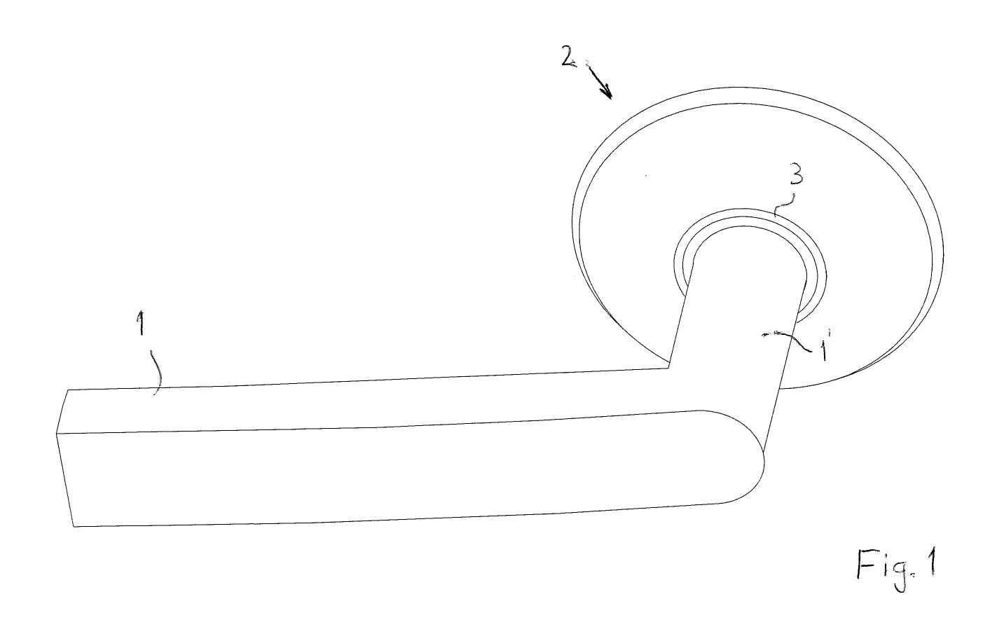

FIG. 1 thus presents a combination of a handle 1 and a face plate 2 according to the invention. The handle 1 thus refers to a doorhandle. The stem part 1′ of the handle 1 goes through the hole in the center of the face plate 2. The task of the face plate is to cover the lock housing, as is known in the art. The lock, of course, comprises a lock case installed in the lock housing, which lock case is not presented in the drawings.

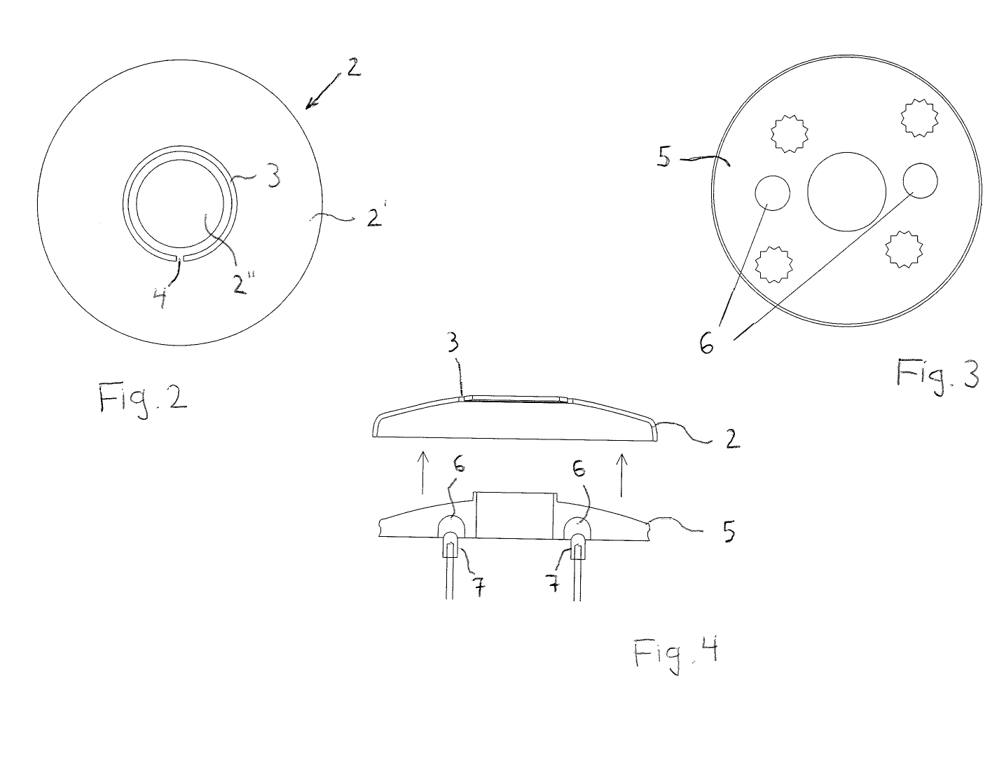

An essentially ring-shaped aperture or groove, which is presented with the reference number 3, is made in the face plate according to the invention. The shape of the aperture 3 is shown in more detail in FIG. 2. It is thus an essentially ring-shaped groove, in which a small fixing bridge 4 is left between the rest of the face plate 2′ and the center part 2″ of the face plate. The fixing bridge 4 must therefore exist for the center part 2″ of the face plate to stay attached to the rest of the face plate 2″. The ring-shaped aperture 3 forming an almost complete circle is therefore an aperture extending through the material of the face plate, which aperture enables light from below the face plate to be visible from the front of the face plate, as described later.

FIG. 3 presents the inside piece 5 belonging to the invention, as viewed from below. The inside piece is of light-diffusing material. On its bottom surface are recesses 6 for LED lights 7 (FIG. 4). In each of the LED lights 7, of which there can be one or more, and in the case presented by the drawings there are two units, there can be one or more colors, e.g. two colors. Since the inside piece 5 is of light-diffusing material, the LED light scatters evenly into the whole of the inside piece. That being the case, also the side of the inside piece 5 that comes against the face plate is illuminated when any or some of the LED lights is/are on. In this way the same even light is visible from the ring-shaped aperture 3 of the face plate 2 for the whole length of the aperture.

Different aspects of the state of the lock can be indicated with the

LED lights. For example, a green light can mean that the door can be opened by pressing the handle. A red light can mean that the opening will not succeed with the “key” used, which key can be any opening method whatsoever that is used in locks. For example, a yellow light can mean that the lock is in administration mode, in which user rights, et cetera, can be changed. It is further possible that in the idle state a white light is illuminated in the lock, in which case it is also visible in the dark. There can be countless others of these different color codes and this invention is not limited to any particular code set. There is, of course, the possibility of making various color combinations in the LED lights by activating more than one LED light at a time. The LED lights receive the current they need e.g. directly from the lock case, so extra wiring is not needed.

FIG. 4 presents how the inside piece 5 and the face plate 6 are installed with respect to each other. They become nested, in the manner presented by FIG. 4. In the invention, therefore, it is essential that the light indicating the status of the lock can be made to be visible from the front of the face plate 2 through the light band (aperture 3). As described above, the aperture is ring-shaped, almost fully circular, and the ring-shaped aperture is disposed around the stem part 1′ of the handle 1. However, all other shapes of the aperture are possible within the scope of the invention. The aperture could be e.g. semicircular, square, rectangular, oval or some other such shape. Also, the aperture does not need to be continuous, but instead it could be formed e.g. from a number of small apertures or holes. Neither does the aperture necessarily need to surround the stem part of the handle, but instead it could be disposed in another point of the face plate.

It is obvious to the person skilled in the art that the different embodiments of the invention are not limited solely to the example described above, but that they may be varied within the scope of the claims presented below.

The characteristic features possibly presented in the description in conjunction with other characteristic features can if necessary be used separately to each other.

1. Arrangement for indicating the state of the lock of a door with indication lights, which lock comprises a lock case installed in a lock housing inside the door, a handle, by means of which the door is opened, and a face plate installed onto the surface of the door, which face plate covers the lock housing and through which the handle is installed, wherein indication lights are installed in the lock case behind the face plate, and in that at least one aperture is made in the face plate, through which aperture the light is visible from the front of the door.

2. Arrangement according to claim 1, wherein the aperture is essentially ring-shaped apart from the fixing bridge between the rest of the face plate and the center part of the face plate, and in that the ring-shaped aperture surrounds the stem part of the handle.

3. Arrangement according to claim 1, wherein an inside piece that is of light-diffusing material is fixed behind the face plate in the lock case, in the bottom side of which inside piece recesses are made for one or more LED lights.

4. Arrangement according to claim 3, wherein there are two LED lights and two different colors are selectable in each of them.

5. Face plate for covering the lock housing of a lock of a door, which face plate is fixed to the door and in the center of which face plate is a hole for the stem part of the handle, wherein at least one aperture is made in the face plate, via which aperture the light coming from under the face plate is visible.

6. Face plate according to claim 6, wherein the aperture is essentially ring-shaped apart from the fixing bridge between the rest of the face plate and the center part of the face plate, and in that the ring-shaped aperture surrounds the stem part of the handle.

7. Arrangement according to claim 2, wherein an inside piece that is of light-diffusing material is fixed behind the face plate in the lock case, in the bottom side of which inside piece recesses are made for one or more LED lights.
